(19) United States
(12) Patent Application Publication
(10) Pub. No.: US 2025/0390055 A1
(43) Pub. Date: Dec. 25, 2025

(54) DEVELOPER STORING DEVICE AND IMAGE FORMING APPARATUS

(71) Applicant: KYOCERA Document Solutions Inc., Osaka (JP)

(72) Inventor: Kazuhiro Okamoto, Osaka (JP)

(21) Appl. No.: 19/236,053

(22) Filed: Jun. 12, 2025

(30) Foreign Application Priority Data
Jun. 21, 2024 (JP) 2024-100383

(51) Int. Cl. G03G 21/12; G03G 15/16; G03G 21/00; G03G 21/10; G03G 21/16

(52) U.S. Cl. CPC G03G 21/12; G03G 15/161; G03G 21/0005; G03G 21/105; G03G 21/1647; G03G 2221/1648

(57) ABSTRACT

A developer storing device according to the present disclosure includes a developer container and a container support portion which retains the developer container at an attachment position. The container support portion includes a bottom surface support portion and a stopper member. The developer container includes a container body, an inlet, an engagement portion, and a step portion. The inlet is provided on an upper surface of the container body. The engagement portion is provided more on a side of a drawing direction than the inlet on the upper surface of the container body, and engages with the stopper member to restrict a movement of the developer container in the drawing direction. The step portion causes, while the inlet passes by the stopper member when the developer container is inserted or drawn out, the container body to be displaced downwardly so that the inlet is separated from the stopper member.

### INCORPORATION BY REFERENCE

This application is based upon and claims the benefit of priority from the corresponding Japanese Patent Application No. 2024-100383 filed on Jun. 21, 2024, the entire contents of which are incorporated herein by reference.

### BACKGROUND

The present disclosure relates to a developer storing device including a developer container capable of storing used developer, and an image forming apparatus including the developer storing device.

In general, an image forming apparatus that uses electrophotography includes a developer container which recovers and accumulates therein used developer that has been used by an imaging portion (hereinafter, will be referred to as “waste developer”). The developer container is detachably attached to an attachment portion provided in the image forming apparatus so as to be exchangeable.

As this type of developer container, there is known, for example, a developer container which is engaged by a stopper provided in the attachment portion in a state where the developer container is attached, so that the developer container is retained at a predetermined attachment position in the attachment portion.

### SUMMARY

A developer storing device according to an aspect of the present disclosure includes a developer container capable of storing used developer that has been recovered in an image forming apparatus, and a container support portion which is provided in the image forming apparatus and retains the developer container inserted into the image forming apparatus from an opening formed on a side surface of the image forming apparatus at a predetermined attachment position.

The container support portion includes a bottom surface support portion which supports a bottom surface of the developer container, and a stopper member which is provided at an upper edge portion of the opening and is supported while being movable between a predetermined evacuation position and a protrusion position at which the stopper member protrudes downwardly from the evacuation position.

The developer container includes a container body, an inlet which is provided near a first end portion of an upper surface of the container body on a side of an insertion direction of the developer container, and causes the developer to flow into the container body, an engagement portion which is provided more on a side of a drawing direction opposite to the insertion direction than the inlet on the upper surface of the container body, and engages with the stopper member positioned at the protrusion position to restrict a movement of the developer container in the drawing direction, and a step portion which extends toward the drawing direction from a second end portion of a bottom surface of the container body on the side of the insertion direction, and causes, while the inlet passes by the stopper member when the developer container is inserted or drawn out, the container body to be displaced downwardly so that the inlet is separated from the stopper member.

An image forming apparatus according to another aspect of the present disclosure includes an apparatus body, an imaging portion which forms a developer image formed of developer on an image-carrying member, a cleaning portion which removes used developer remaining on the image-carrying member, a developer container capable of storing the used developer removed by the cleaning portion, and a container support portion which retains the developer container inserted into the apparatus body from an opening formed on a side surface of the apparatus body at a predetermined attachment position.

The container support portion includes a bottom surface support portion which supports a bottom surface of the developer container, and a stopper member which is provided at an upper edge portion of the opening and is supported while being movable between a predetermined evacuation position and a protrusion position at which the stopper member protrudes downwardly from the evacuation position.

The developer container includes a container body, an inlet which is provided near a first end portion of an upper surface of the container body on a side of an insertion direction of the developer container, and causes the developer to flow into the container body, an engagement portion which is provided more on a side of a drawing direction opposite to the insertion direction than the inlet on the upper surface of the container body, and engages with the stopper member positioned at the protrusion position to restrict a movement of the developer container in the drawing direction, and a step portion which extends toward the drawing direction from a second end portion of a bottom surface of the container body on the side of the insertion direction, and causes, while the inlet passes by the stopper member when the developer container is inserted or drawn out, the container body to be displaced downwardly so that the inlet is separated from the stopper member.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a perspective view showing a configuration of an image forming apparatus according to an embodiment of the present disclosure;

FIG. 2 is a schematic diagram showing an internal configuration of the image forming apparatus;

FIG. 3 is a partially-enlarged view of a main portion III shown in FIG. 1, the diagram showing a peripheral configuration of a container attachment portion included in the image forming apparatus;

FIG. 4 is a side view schematically showing a configuration of the container attachment portion to which a recovery container is attached;

FIG. 5 is a perspective view showing a configuration of the recovery container;

FIG. 6 is a perspective view showing the configuration of the recovery container;

FIG. 7A is a diagram showing an attachment operation of the recovery container;

FIG. 7B is a diagram showing the attachment operation of the recovery container;

FIG. 7C is a diagram showing the attachment operation of the recovery container;

FIG. 8A is a diagram showing a removal operation of the recovery container;

FIG. 8B is a diagram showing the removal operation of the recovery container; and

FIG. 8C is a diagram showing the removal operation of the recovery container.

### DETAILED DESCRIPTION

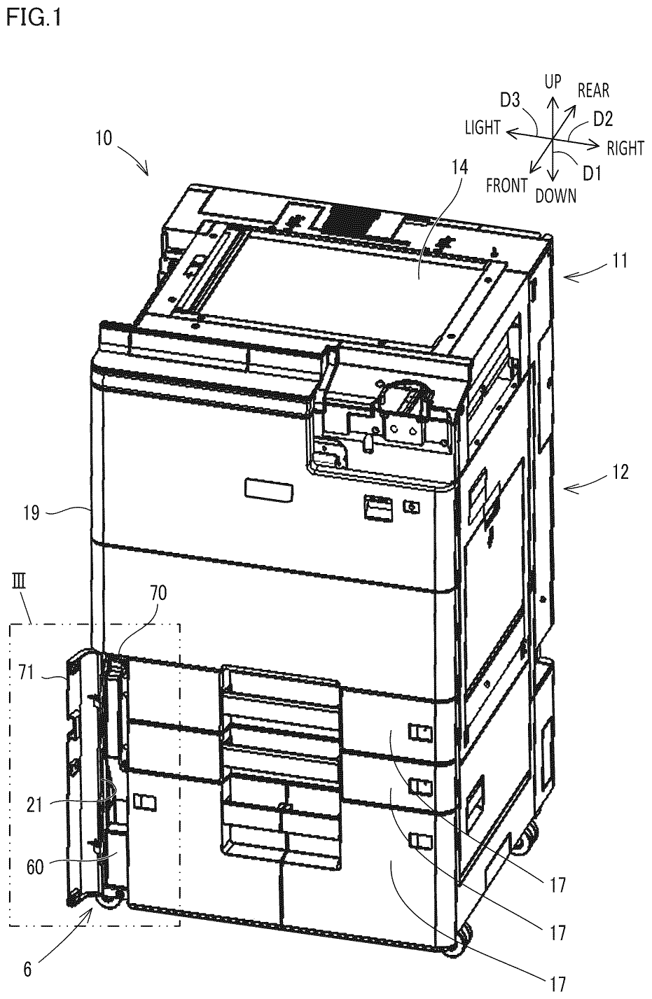

Hereinafter, an embodiment of the present disclosure will be described with reference to the drawings as appropriate. The following embodiment is an example of embodying the present disclosure and does not limit the technical scope of the present disclosure. It is noted that for convenience of descriptions, an up-down direction D1, a front-rear direction D2, and a left-right direction D3 are defined in a state where an image forming apparatus 10 is installed in a usable state (a state shown in FIG. 1).

A configuration of the image forming apparatus 10 (an example of an image forming apparatus according to the present disclosure) will be described with reference to FIG. 1. Herein, FIG. 1 is a perspective view of the image forming apparatus 10 according to the embodiment of the present disclosure. It is noted that in FIG. 1, an illustration of a document sheet cover at an upper portion of the image forming apparatus 10 is omitted.

The image forming apparatus 10 is a multifunction peripheral having a printing function, a copying function, a scanning function, a facsimile function, and the like. As shown in FIG. 1, the image forming apparatus 10 includes an image reading device 11, an image forming portion 12, and the like.

The image reading device 11 is a device that reads an image of a document sheet placed on a document sheet placing table 14. The image reading device 11 is provided at the upper portion of the image forming apparatus 10. The image reading device 11 includes the document sheet placing table 14, a reading unit (not shown), a document sheet holder (not shown), and the like. The image reading device 11 performs processing of reading an image from a still document sheet placed on the document sheet placing table 14.

Although the image forming apparatus 10 including the image reading device 11 is described as an example in the present embodiment, the present disclosure is not limited thereto. For example, the present disclosure is also applicable to a printer (image forming apparatus) having only a printing function for forming an image on a sheet using developer.

The image forming portion 12 forms a color or monochrome image on a sheet using electrophotography based on image data read by the image reading device 11 or image data input from an external information processing apparatus such as a personal computer. The sheet is a sheet-like image forming medium (transfer medium) such as a paper sheet or an envelope. The sheet on which an image has been formed is discharged onto a sheet discharge tray (not shown).

It is noted that although the image forming portion 12 that uses electrophotography is described as an example in the present embodiment, the image forming portion 12 is not limited to one that uses electrophotography and may use any recording method or printing method as long as an image is formed using developer such as toner.

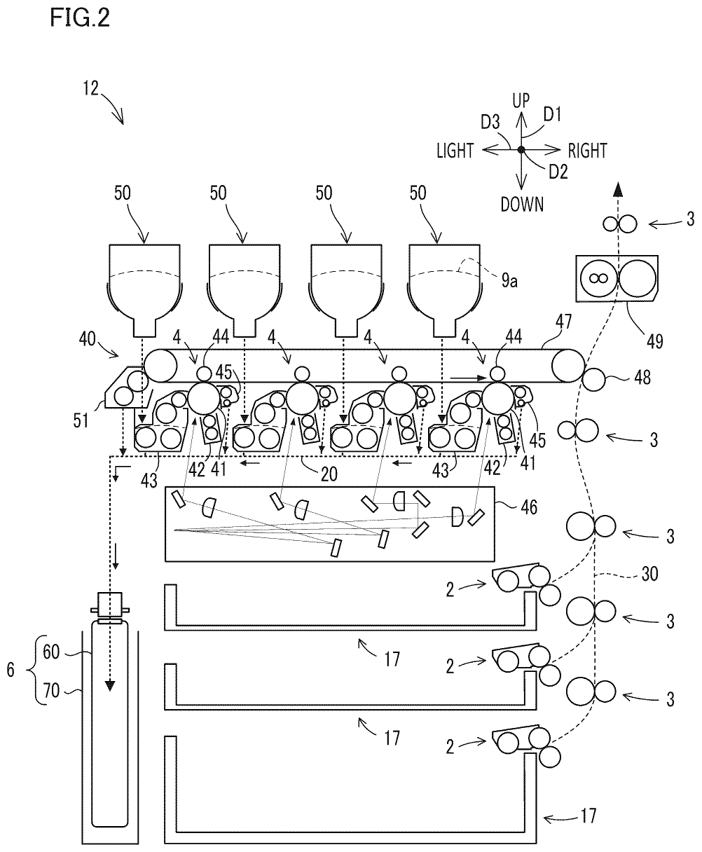

FIG. 2 is a schematic diagram showing a configuration of the image forming portion 12. As shown in FIG. 2, the image forming portion 12 includes a housing 19 as an apparatus body, a sheet storing portion 17, a sheet feed portion 2, a sheet conveying portion 3, an imaging portion 40 (an example of an imaging portion according to the present disclosure), a laser scanning portion 46, a fixing portion 49, toner replenishing portions 50, and a waste toner storing device 6 (an example of a developer storing device according to the present disclosure).

The imaging portion 40 executes image forming processing for forming an image on a sheet using a developer. The imaging portion 40 includes image forming units 4, a device used for development, a device used for conveying the developer, and the like. The developer is two-component developer containing toner and a carrier.

The imaging portion 40 includes a plurality of image forming units 4 respectively corresponding to a plurality of colors of toner, an intermediate transfer belt 47 (an example of an image-carrying member according to the present disclosure), a secondary transfer portion 48, and a belt cleaning portion 51 (an example of a cleaning portion according to the present disclosure). In addition, the plurality of toner replenishing portions 50 are also respectively provided with respect to the colors of toner. In the present embodiment, the imaging portion 40 includes four image forming units 4.

Each of the image forming units 4 includes a photoconductor drum 41 (an example of the image-carrying member according to the present disclosure), a charging portion 42, a developing portion 43, a primary transfer portion 44, and a drum cleaning portion 45 (an example of the cleaning portion according to the present disclosure). In the image forming unit 4 of the imaging portion 40, the developing portion 43 forms a toner image (an example of a developer image) on an outer circumferential surface of the photoconductor drum 41. Further, in the imaging portion 40, the primary transfer portion 44 transfers the toner image formed on the photoconductor drum 41 onto the intermediate transfer belt 47.

The sheet storing portion 17 stores sheets to be fed by the sheet feed portion 2. The sheet feed portion 2 takes out a sheet from the sheet storing portion 17 and feeds the sheet to a sheet conveying path 30. The sheet conveying portion 3 conveys the sheet fed by the sheet feed portion 2 toward a downstream side of a sheet feed direction along the sheet conveying path 30. The intermediate transfer belt 47 is an endless belt-like member, and rotates while being stretched across two rollers.

In each of the image forming units 4, a drum-type photoconductor drum 41 rotates, and the charging portion 42 uniformly charges a surface of the photoconductor drum 41. The laser scanning portion 46 scans laser light so as to write an electrostatic latent image on the surface of the photoconductor drum 41.

The developing portion 43 develops the electrostatic latent image into a toner image using developer containing a carrier stored in advance and unused toner supplied from the toner replenishing portion 50. Thus, the toner image is formed on the surface of the photoconductor drum 41.

The primary transfer portion 44 transfers the toner image formed on the surface of the photoconductor drum 41 onto the intermediate transfer belt 47. Then, the toner image is transferred from each of the plurality of photoconductor drums 41 onto the intermediate transfer belt 47. Thus, a color toner image in which the toner images of the respective colors are superimposed is formed on the intermediate transfer belt 47.

The secondary transfer portion 48 transfers the color toner image formed on the intermediate transfer belt 47 onto the sheet. The fixing portion 49 fixes the color toner image onto the sheet by heating. After that, the sheet onto which the image has been fixed is discharged onto the sheet discharge tray (not shown).

The drum cleaning portion 45 removes the toner (used toner) remaining on the surface of the photoconductor drum 41 after the transfer by the primary transfer portion 44. The drum cleaning portion 45 includes, for example, a cleaning member such as a cleaning blade or a cleaning roller that comes into contact with the surface of the photoconductor drum 41 to remove the used toner, and a conveying member such as a spiral shaft provided inside a housing of the drum cleaning portion 45. The conveying member is driven by a drive portion such as a motor (not shown), so that the conveying member conveys the toner accumulated at a bottom portion of the housing to a conveying path 20 (see FIG. 2) inside the housing 19.

The belt cleaning portion 51 removes the toner (used toner) remaining on the surface of the intermediate transfer belt 47 after the transfer by the secondary transfer portion 48. The belt cleaning portion 51 includes, for example, a cleaning member such as a cleaning blade or a cleaning roller that comes into contact with the surface of the intermediate transfer belt 47 to remove the used toner, and a conveying member such as a spiral shaft provided inside a housing of the belt cleaning portion 51. The conveying member is driven by a drive portion such as a motor (not shown), so that the conveying member conveys the toner accumulated at a bottom portion of the housing to the conveying path 20.

The used toner conveyed from the drum cleaning portion 45 and the belt cleaning portion 51 to the conveying path 20 is an example of used developer according to the present disclosure. The used toner is toner to be discarded or recycled and will hereinafter be referred to as waste toner.

A toner conveying member for conveying the waste toner to the waste toner storing device 6 is provided on the conveying path 20. The toner conveying member is driven by drive portion such as a motor (not shown), so that the waste toner in the conveying path 20 is conveyed toward the waste toner storing device 6.

The waste toner storing device 6 includes a recovery container 60 (an example of a developer container according to the present disclosure) for storing the waste toner and a container attachment portion 70 (an example of a container support portion according to the present disclosure) that supports the recovery container 60. The waste toner removed from the photoconductor drum 41 and the intermediate transfer belt 47 by the drum cleaning portion 45 and the belt cleaning portion 51 is conveyed to the waste toner storing device 6 to be stored inside the recovery container 60.

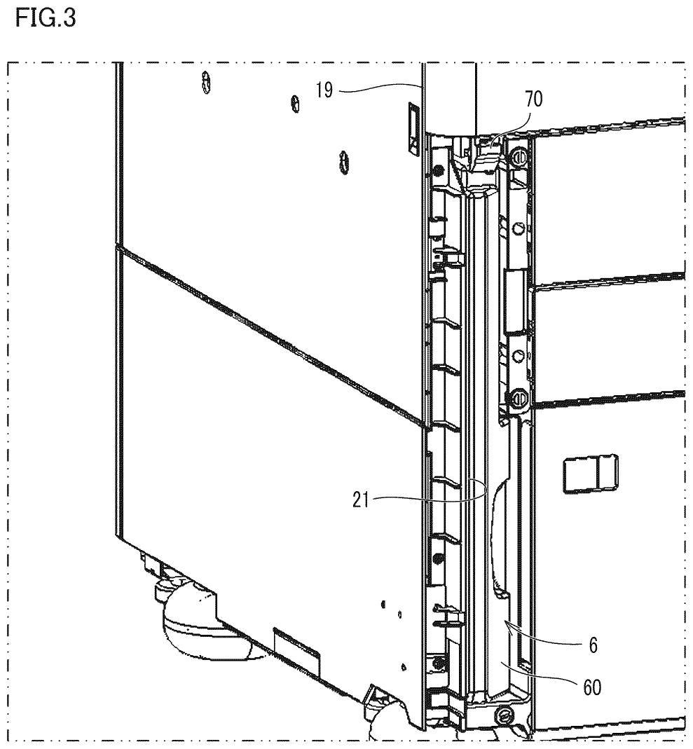

FIG. 3 is a partially-enlarged view showing a peripheral configuration of the container attachment portion 70. As shown in FIG. 3, the container attachment portion 70 is provided at a left end portion of a lower front surface of the housing 19.

The housing 19 includes an opening 21 at a lower portion of the left end portion of the front surface thereof. The opening 21 is formed in a vertically-long rectangular shape that is narrow in the left-right direction D3 and is long in the up-down direction D1. The container attachment portion 70 is provided on a rear side of the opening 21.

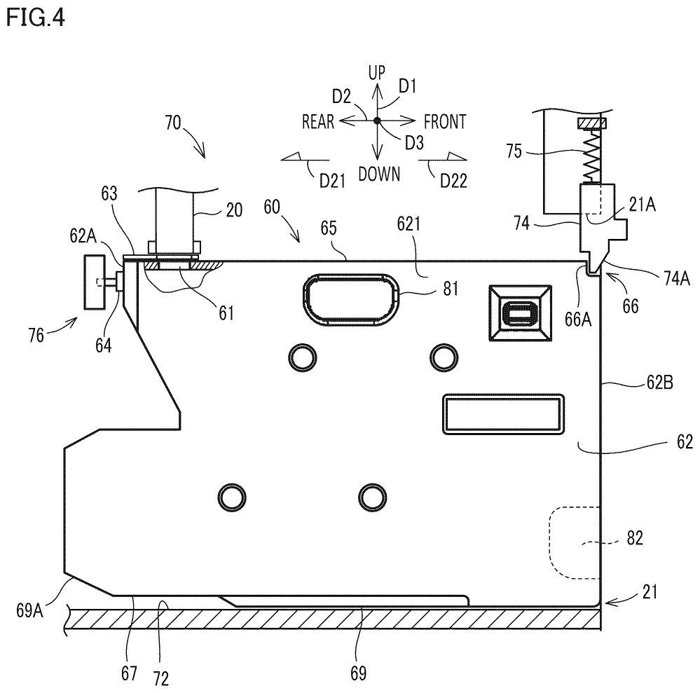

The container attachment portion 70 includes a container storing chamber that is formed from the opening 21 to the inside. The container attachment portion 70 retains the recovery container 60 that has been inserted into the container storing chamber from the opening 21 at a predetermined attachment position (the position shown in FIG. 4). The container attachment portion 70 detachably supports the recovery container 60.

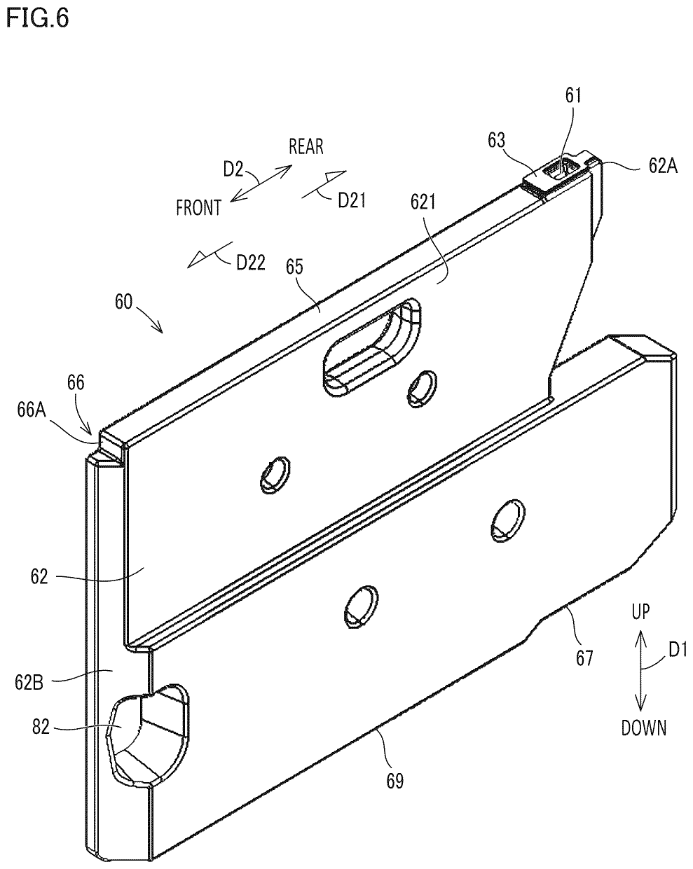

The container attachment portion 70 includes a cover 71 (see FIG. 1) that is displaced between a closing position that closes the opening 21 and an opening position that opens the opening 21. The cover 71 rotates between the closing position and the opening position using a hinge portion (not shown) provided at a left edge portion of the opening 21 as a rotation fulcrum, to thus open and close the opening 21. When the cover 71 is opened, the recovery container 60 is exposed to the outside through the opening 21. This allows a user to grasp a second handle 82 (see FIG. 6) provided at a front end portion of the recovery container 60 so as to draw out the recovery container 60 from the container attachment portion 70.

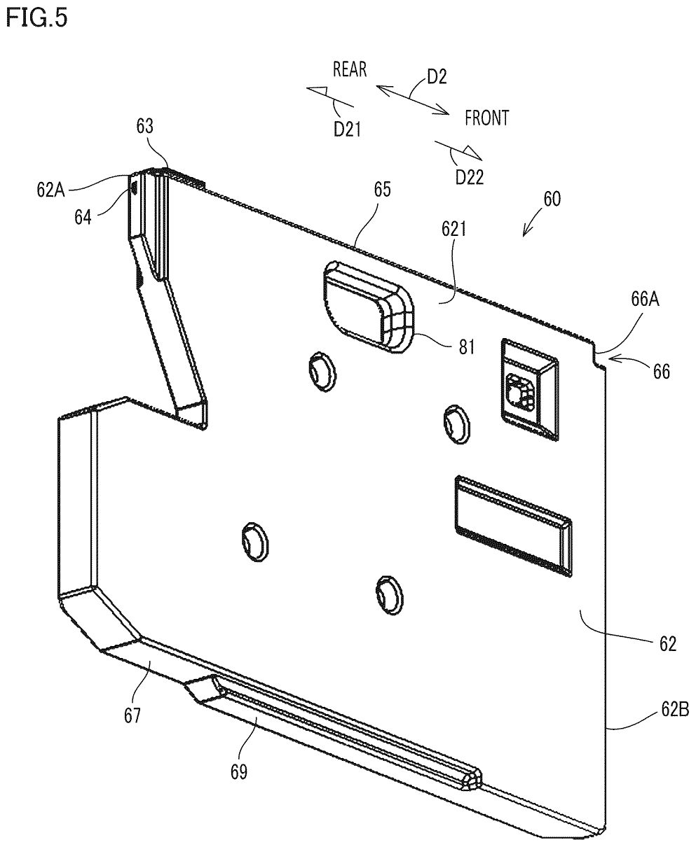

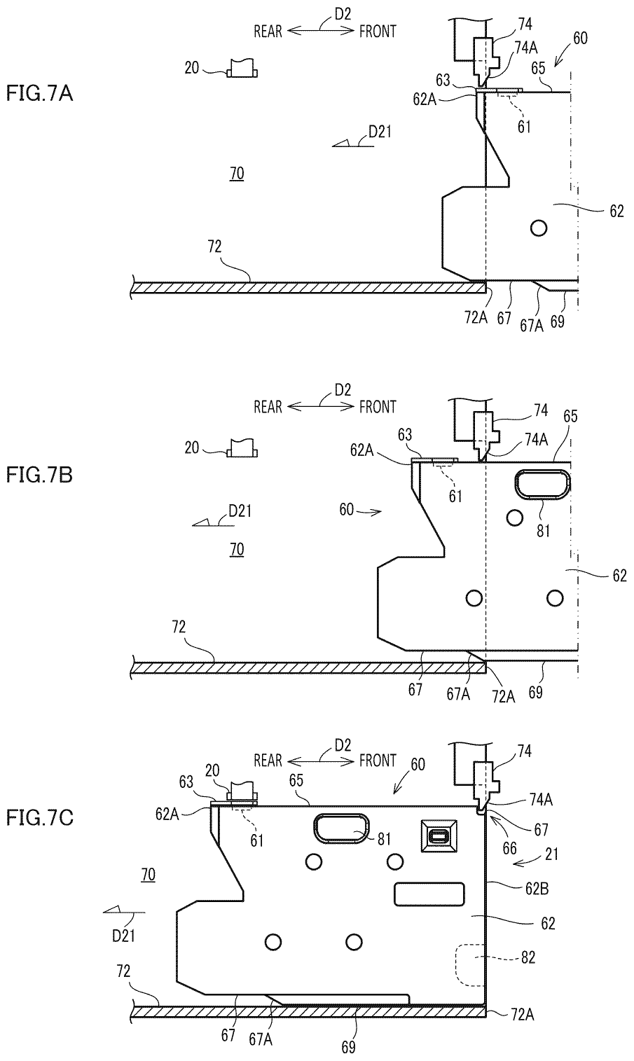

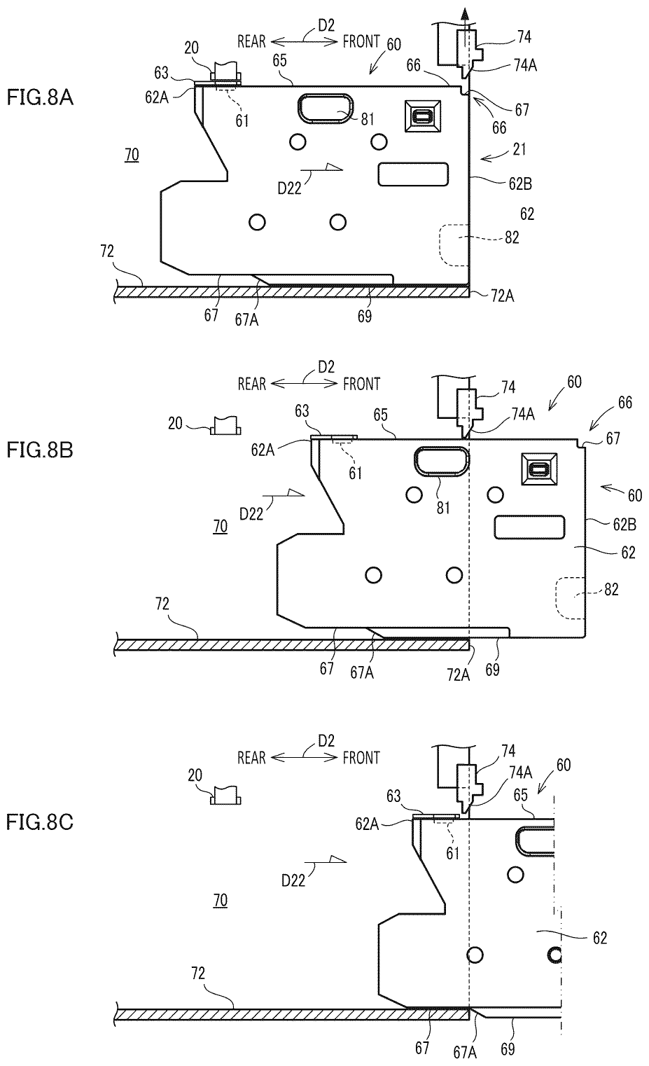

FIG. 4 is a side view schematically showing a configuration of the container attachment portion 70. FIG. 4 shows a state where the recovery container 60 is attached to the container attachment portion 70. FIG. 5 and FIG. 6 are each a perspective view showing the recovery container 60. In FIG. 5 and FIG. 6, the up-down direction D1, the front-rear direction D2, and the left-right direction D3 are defined using an attachment attitude of the recovery container 60 with respect to the container attachment portion 70 as a reference. FIG. 7A, FIG. 7B, and FIG. 7C are diagrams showing an attachment operation of the recovery container 60. FIG. 8A, FIG. 8B, and FIG. 8C are each a diagram showing a removal operation of the recovery container 60.

As shown in FIG. 4, the container attachment portion 70 includes a flat support surface 72 (an example of a bottom surface support portion according to the present disclosure) that supports a bottom portion 69 of the recovery container 60, and a stopper member 74 (an example of a stopper member according to the present disclosure) that retains, at the attachment position, the recovery container 60 attached at the attachment position.

The support surface 72 is a flat support plate that extends rearwardly from a lower end portion of the opening 21, and forms a part of a bottom plate of the housing 19. The support surface 72 supports the bottom portion 69 of the recovery container 60 such that the bottom portion 69 becomes slidable in the front-rear direction D2.

The stopper member 74 is provided in the housing 19. The stopper member 74 is provided at an upper portion of the container storing chamber formed inside the housing 19. Specifically, the stopper member 74 is supported by an upper edge portion 21A of the opening 21 so as to be movable in the up-down direction D1. The stopper member 74 is supported so as to be movable between a protrusion position (an example of a protrusion position according to the present disclosure) at which the stopper member 74 protrudes downwardly from the upper edge portion 21A so as to be capable of locking the recovery container 60 and an evacuation position (an example of an evacuation position according to the present disclosure) at which the stopper member 74 evacuates inside the upper edge portion 21A so as to unlock the recovery container 60. FIG. 4 shows a state where the stopper member 74 is at the protrusion position and is locking the recovery container 60 so that it does not move forward.

In the present embodiment, in a container-attached state where the recovery container 60 is attached at the attachment position of the container attachment portion 70 (state shown in FIG. 4), the stopper member 74 is arranged at the protrusion position. When the stopper member 74 is at the protrusion position in the container-attached state, a lock piece 74A at a lower end portion of the stopper member 74 abuts against a front surface portion 66A of a restriction portion 66 (see FIG. 5) (an example of an engagement portion according to the present disclosure) of the recovery container 60. Thus, a forward movement of the recovery container 60 from the attachment position is restricted. As a result, the recovery container 60 can be stably retained at the attachment position in the container attachment portion 70.

A front surface of the lock piece 74A is a tilted surface that is tilted obliquely upwardly toward the front. Therefore, when a rear end portion 62A of an upper surface portion 65 (an example of the first end of the present disclosure) constituting an upper surface of a container body 62 abuts against the tilted surface during a process in which the recovery container 60 is inserted toward the attachment position of the container attachment portion 70, the stopper member 74 is lifted upwardly by a principle of a tilt cam. This allows the stopper member 74 to be moved from the protrusion position to the evacuation position, and thus the recovery container 60 can be inserted into the container storing chamber provided inside from the opening 21. It is noted that it is also possible to cause the stopper member 74 to move from the protrusion position to the evacuation position by a user manually operating the stopper member 74 to move the stopper member 74 upwardly.

When the recovery container 60 is drawn out forwardly from the attachment position of the container attachment portion 70, the user needs to manually operate the stopper member 74 to move the stopper member 74 upwardly and release the engagement of the stopper member 74 with the restriction portion 66. After the engagement of the stopper member 74 is released, the container attachment portion 70 can be drawn out forwardly from the attachment position.

When the stopper member 74 is in a free state during the process of drawing out the container after the engagement by the stopper member 74 is released, the stopper member 74 may move downwardly so that a tip end thereof slides on the upper surface portion 65 of the recovery container 60, to thus come into contact with an inlet 61 (an example of an inlet according to the present disclosure) to be described later that is formed at the upper surface portion 65. This causes the waste toner to adhere onto the periphery of the inlet 61 or the waste toner to adhere onto the stopper member 74. In this case, there is a problem that the waste toner may be spilled onto the floor after the recovery container 60 is drawn out to smear the floor, or a finger of the user may become dirty when operating the stopper member 74.

To solve such a problem, a step portion 67 (see FIG. 4) to be described later is provided in the recovery container 60. Thus, it becomes possible to draw out the recovery container 60 from the container attachment portion 70 without bringing the stopper member 74 into contact with the inlet 61 of the recovery container 60.

The container attachment portion 70 includes a bias member 75 (an example of a bias member according to the present disclosure) that biases the stopper member 74 toward the protrusion position. The bias member 75 is, for example, an elastic member having elasticity such as a coil spring, a sponge member, and a rubber member. The bias member 75 applies an elastic force that presses the stopper member 74 downwardly. Since the stopper member 74 is pressed downwardly by such an elastic force, the recovery container 60 is restricted at the attachment position for certain.

Further, as shown in FIG. 4, the container attachment portion 70 includes a sensor 76 (an example of a container detection portion according to the present disclosure) capable of detecting the recovery container 60 attached at the attachment position. The sensor 76 is, for example, a limit switch in which a contact point comes into contact or is released when pressed, or an optical sensor such as a transmissive photo interrupter in which an output value changes when light is blocked. In the present embodiment, by a protrusion 64 (an example of a protrusion portion according to the present disclosure) of the recovery container 60 acting on the sensor 76 when the recovery container 60 is attached at the attachment position, the recovery container 60 is detected by the sensor 76.

The recovery container 60 is removably (detachably) attached to the container attachment portion 70 via the opening 21. The recovery container 60 is a container that is hollow inside and stores therein waste toner discharged from the imaging portion 40.

As shown in FIG. 5 and FIG. 6, the recovery container 60 includes the container body 62 (an example of the container body according to the present disclosure) that accumulates the waste toner, the restriction portion 66, and the inlet 61 (an example of the inlet according to the present disclosure) through which the waste toner is guided inside.

The container body 62 is formed by blow molding. That is, the container body 62 is formed by blowing a molten resin between two molds attached to each other. One of the two molds forms a shape of one side of the container body 62 in the width direction (left side), and the other mold forms a shape of the other side of the container body 62 in the width direction (right side).

The container body 62 is formed in a shape in which a size in an insertion direction D21 and a size in the up-down direction D1 are larger than a size in the width direction (left-right direction D3) orthogonal to the insertion direction D21. In other words, the container body 62 is formed in a shape that is narrow in the left-right direction D3, is long in the up-down direction D1 and the front-rear direction D2, and is flat in the width direction (left-right direction D3). Herein, the insertion direction D21 is a direction in which the recovery container 60 is inserted from the opening 21 toward a back portion of the container attachment portion 70 when attaching the recovery container 60 to the container attachment portion 70.

The restriction portion 66 is provided at the upper surface portion 65 of the container body 62. The restriction portion 66 engages with the stopper member 74 positioned at the protrusion position to restrict the forward movement of the recovery container 60 from the attachment position.

The restriction portion 66 is provided more on a drawing direction D22 (front) side of the recovery container 60 than the inlet 61 at the upper surface portion 65 of the container body 62. Specifically, the restriction portion 66 is provided at an end portion of the upper surface portion 65 in the drawing direction D22. The restriction portion 66 is formed integrally with the container body 62. At the end portion of the upper surface portion 65 of the container body 62 in the drawing direction D22, a step that is one step lower than the flat upper surface portion 65 of the container body 62 is formed, and this step is the restriction portion 66.

The inlet 61 is an inlet that causes the waste toner discharged from the imaging portion 40 via the conveying path 20 to flow into the recovery container 60. The inlet 61 is formed in a size, shape, and position that enables the waste toner to flow in when the recovery container 60 is in an attached state where the recovery container 60 is attached to the container attachment portion 70. In the present embodiment, the inlet 61 is provided at the upper surface portion 65 of the container body 62, and is arranged at a position capable of communicating with an outlet at a lower end of the conveying path 20 in the attached state. Specifically, the inlet 61 is provided in the vicinity of the rear end portion 62A of the upper surface portion 65 of the container body 62 on the insertion direction D21 side.

A sheet-like sealing member 63 is attached to the upper surface portion 65 of the container body 62. A through-hole having approximately the same size as the inlet 61 is formed in the sealing member 63, and the sealing member 63 is attached to the upper surface portion 65 in a state where the through-hole is positioned at the inlet 61. The sealing member 63 is formed of, for example, a nonwoven fabric, a sponge member, or the like, and is attached to the upper surface portion 65 by an adhesive or the like.

As shown in FIG. 5, the protrusion 64 is formed on the rear surface of the container body 62. The protrusion 64 is formed at an upper end portion of the rear surface of the container body 62. The protrusion 64 is formed integrally with the container body 62. The protrusion 64 is a portion that is detected by the sensor 76 (see FIG. 4) when the recovery container 60 is attached at the attachment position.

In the present embodiment, the protrusion 64 is formed by cavities formed on mating surfaces of the two molds attached to each other when the container body 62 is formed by the blow molding as described above. By forming the protrusion 64 by the blow molding of the container body 62 in this manner, the rib-like protrusion 64 that is elongated in the up-down direction D1 is formed on the rear surface of the container body 62. Thus, it becomes possible to form the protrusion 64 having high positional accuracy and dimensional accuracy on the container body 62 even by the blow molding, and as a result, the recovery container 60 at the attachment position can be detected for certain.

As shown in FIG. 6, the recovery container 60 includes a first handle 81 and the second handle 82. Each of the handles 81 and 82 is formed integrally with the container body 62.

The first handle 81 is provided at an upper portion 621 of the container body 62. For example, the first handle 81 penetrates the container body 62 in the width direction (left-right direction D3) at the upper portion 621 of the container body 62. Therefore, the user can easily grasp the upper portion 621 of the container body 62 by hooking a finger on the first handle 81 or the like. It is noted that the shape of the first handle 81 may be any shape as long as the user can grasp the first handle 81 with his/her hand, and may be, for example, a dented shape, a hook shape, or the like.

In the present embodiment, the first handle 81 is formed at substantially a center portion of the upper portion 621 of the container body 62 in the front-rear direction D2.

The second handle 82 is a portion that is grasped by the user when drawing out the recovery container 60 positioned at the attachment position, and is provided at a front end portion 62B of the container body 62 on the drawing direction D22 side.

For example, the second handle 82 is formed at a lower end portion of the front end portion 62B. As shown in FIG. 6, the second handle 82 is a concave portion formed on a right side surface of the container body 62 so as to enable the user to easily hook a finger/fingers from above.

As shown in FIG. 5, the recovery container 60 includes the step portion 67 (an example of the step portion according to the present disclosure). The step portion 67 is formed at the bottom portion 69 constituting the bottom surface of the recovery container 60. The step portion 67 extends from a rear end portion 69A (an example of a second end portion according to the present disclosure) of the bottom portion 69 on the insertion direction side toward the drawing direction D22. The step portion 67 is a step surface that is spaced one step above the flat bottom portion 69. A tilted surface 67A is formed between the step portion 67 and the bottom portion 69 to facilitate climbing on the support surface 72.

The step portion 67 is a portion supported by the support surface 72 when the recovery container 60 is inserted from the opening 21. When the recovery container 60 is inserted, the step portion 67 slides in the insertion direction D21 while being supported by the support surface 72, whereby, while the inlet 61 passes by the stopper member 74, the container body 62 is displaced downwardly so that the inlet 61 is separated downwardly from the tip end of the stopper member 74.

Furthermore, the step portion 67 is also a portion supported by the support surface 72 when the recovery container 60 attached at the attachment position is drawn out. When drawing out the recovery container 60, the step portion 67 slides in the drawing direction D22 while being supported by the support surface 72, whereby, while the inlet 61 passes by the stopper member 74, the container body 62 is displaced downwardly so that the inlet 61 is separated downwardly from the tip end of the stopper member 74.

Since the recovery container 60 is configured in this manner, when the recovery container 60 is inserted into the opening 21 for attachment, the step portion 67 is first supported by the support surface 72 as shown in FIG. 7A. In this state, a gap is generated between the sealing member 63 of the upper surface portion 65 and the tip end of the stopper member 74. In other words, the stopper member 74 is not in contact with the inlet 61 or the sealing member 63 at the upper surface portion 65.

In this state, when the recovery container 60 is inserted in the insertion direction D21, the tilted surface 67A abuts against a front end portion 72A of the support surface 72, and the bottom portion 69 climbs up on the support surface 72 to be supported by the support surface 72 (see FIG. 7B). At this time, the recovery container 60 is displaced upwardly by an amount corresponding to the step between the step portion 67 and the bottom portion 69, and the upper surface portion 65 is also displaced upwardly. Thus, the upper surface portion 65 abuts against the tip end of the stopper member 74 to lift up the stopper member 74. As a result, the stopper member 74 is displaced from the protrusion position toward the evacuation position.

Then, when the recovery container 60 is further inserted, the lock piece 74A of the stopper member 74 slides on the flat upper surface portion 65. Then, when the recovery container 60 reaches the attachment position, the lock piece 74A of the stopper member 74 drops into the restriction portion 66 to engage with the restriction portion 66 (see FIG. 7C). Thus, the forward movement of the recovery container 60 from the attachment position is restricted.

Thus, when the recovery container 60 is inserted, even when the stopper member 74 is in the free state during the process of inserting the recovery container 60 after the engagement by the stopper member 74 is released, the stopper member 74 does not come into contact with the inlet 61 or the sealing member 63 at the upper surface portion 65. Therefore, when the recovery container 60 is inserted, the waste toner does not adhere onto the periphery of the inlet 61, or the waste toner does not adhere onto the stopper member 74. In addition, peeling of the sealing member 63 due to the contact with the stopper member 74 is prevented from occurring.

Further, when the recovery container 60 is drawn out from the container attachment portion 70, the user manually moves the stopper member 74 upwardly to release the lock on the restriction portion 66 (see FIG. 8A). In this state, the user grasps the second handle 82 of the recovery container 60 and pulls out the recovery container 60 in the drawing direction D22 to forwardly draw out the recovery container 60.

In this state, the recovery container 60 is drawn out in the drawing direction D22. At this time, when the user releases the stopper member 74, the lock piece 74A of the stopper member 74 abuts against the flat upper surface portion 65, and the recovery container 60 moves in the drawing direction D22 in this state (see FIG. 8B).

Then, when the recovery container 60 is further drawn out in the drawing direction D22 and the tilted surface 67A reaches the front end portion 72A of the support surface 72, the bottom portion 69 is no longer supported by the support surface 72, and the step portion 67 is supported by the support surface 72 (see FIG. 8C). At this time, the recovery container 60 is displaced downwardly by the amount corresponding to the step between the step portion 67 and the bottom portion 69, and the upper surface portion 65 is also displaced downwardly. Thus, the upper surface portion 65 is no longer in contact with the tip end of the stopper member 74, and a gap is generated between the stopper member 74 and the upper surface portion 65. In this state, since the inlet 61 and the sealing member 63 have not yet passed by the stopper member 74, the inlet 61 and the sealing member 63 will not come into contact with the stopper member 74. Then, by being further drawn out, the recovery container 60 is removed from the container attachment portion 70.

Thus, when the recovery container 60 is drawn out, even when the stopper member 74 is in the free state after the engagement by the stopper member 74 is released, the stopper member 74 does not come into contact with the inlet 61 or the sealing member 63 at the upper surface portion 65. Therefore, when the recovery container 60 is drawn out, the waste toner does not adhere onto the periphery of the inlet 61, or the waste toner does not adhere onto the stopper member 74, and thus the waste toner will not be spilled onto the floor to smear the floor, or the finger of the user will not get dirty when operating the stopper member 74. In addition, the sealing member 63 is prevented from being peeled off.

### NOTES OF DISCLOSURE

Hereinafter, a general outline of the invention extracted from the embodiment described above will be noted. It is noted that the respective configurations and processing functions described in the notes below can be sorted and arbitrarily combined as appropriate.

### <Note 1>

A developer storing device, including:
a developer container capable of storing used developer that has been recovered in an image forming apparatus; and
a container support portion which is provided in the image forming apparatus and retains the developer container inserted into the image forming apparatus from an opening formed on a side surface of the image forming apparatus at a predetermined attachment position, in which
the container support portion includes
a bottom surface support portion which supports a bottom surface of the developer container, and
a stopper member which is provided at an upper edge portion of the opening and is supported while being movable between a predetermined evacuation position and a protrusion position at which the stopper member protrudes downwardly from the evacuation position, and
the developer container includes
a container body,
an inlet which is provided near a first end portion of an upper surface of the container body on a side of an insertion direction of the developer container, and causes the developer to flow into the container body,
an engagement portion which is provided more on a side of a drawing direction opposite to the insertion direction than the inlet on the upper surface of the container body, and engages with the stopper member positioned at the protrusion position to restrict a movement of the developer container in the drawing direction, and
a step portion which extends toward the drawing direction from a second end portion of a bottom surface of the container body on the side of the insertion direction, and causes, while the inlet passes by the stopper member when the developer container is inserted or drawn out, the container body to be displaced downwardly so that the inlet is separated from the stopper member.

<Note 2>

The developer storing device according to note 1, further including:
a bias member which biases the stopper member toward the protrusion position.

### <Note 3>

The developer storing device according to note 1 or 2, in which
the container body is formed in a shape in which a size in the insertion direction and a size in an up-down direction are larger than a size in a width direction orthogonal to the insertion direction.

### <Note 4>

The developer storing device according to any one of notes 1 to 3, in which
the container support portion includes
a container detection portion capable of detecting the developer container at the attachment position,
the container body includes a protrusion portion which is detected by the container detection portion when the developer container is attached at the attachment position,
the container body is formed by blow-molding a molten resin between two molds attached to each other, and
the protrusion portion is formed by cavities formed on mating surfaces of the two molds.

### <Note 5>

An image forming apparatus, including:
an apparatus body;
an imaging portion which forms a developer image formed of developer on an image-carrying member;
a cleaning portion which removes used developer remaining on the image-carrying member;
a developer container capable of storing the used developer removed by the cleaning portion; and
a container support portion which retains the developer container inserted into the apparatus body from an opening formed on a side surface of the apparatus body at a predetermined attachment position, in which
the container support portion includes
a bottom surface support portion which supports a bottom surface of the developer container, and
a stopper member which is provided at an upper edge portion of the opening and is supported while being movable between a predetermined evacuation position and a protrusion position at which the stopper member protrudes downwardly from the evacuation position, and
the developer container includes
a container body,
an inlet which is provided near a first end portion of an upper surface of the container body on a side of an insertion direction of the developer container, and causes the developer to flow into the container body,
an engagement portion which is provided more on a side of a drawing direction opposite to the insertion direction than the inlet on the upper surface of the container body, and engages with the stopper member positioned at the protrusion position to restrict a movement of the developer container in the drawing direction, and
a step portion which extends toward the drawing direction from a second end portion of a bottom surface of the container body on the side of the insertion direction, and causes, while the inlet passes by the stopper member when the developer container is inserted or drawn out, the container body to be displaced downwardly so that the inlet is separated from the stopper member.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A developer storing device, comprising:
a developer container capable of storing used developer that has been recovered in an image forming apparatus; and
a container support portion which is provided in the image forming apparatus and retains the developer container inserted into the image forming apparatus from an opening formed on a side surface of the image forming apparatus at a predetermined attachment position, wherein
the container support portion includes
a bottom surface support portion which supports a bottom surface of the developer container, and
a stopper member which is provided at an upper edge portion of the opening and is supported while being movable between a predetermined evacuation position and a protrusion position at which the stopper member protrudes downwardly from the evacuation position, and
the developer container includes
a container body,
an inlet which is provided near a first end portion of an upper surface of the container body on a side of an insertion direction of the developer container, and causes the developer to flow into the container body,
an engagement portion which is provided more on a side of a drawing direction opposite to the insertion direction than the inlet on the upper surface of the container body, and engages with the stopper member positioned at the protrusion position to restrict a movement of the developer container in the drawing direction, and
a step portion which extends toward the drawing direction from a second end portion of a bottom surface of the container body on the side of the insertion direction, and causes, while the inlet passes by the stopper member when the developer container is inserted or drawn out, the container body to be displaced downwardly so that the inlet is separated from the stopper member.

2. The developer storing device according to claim 1, further comprising:
a bias member which biases the stopper member toward the protrusion position.

3. The developer storing device according to claim 1, wherein
the container body is formed in a shape in which a size in the insertion direction and a size in an up-down direction are larger than a size in a width direction orthogonal to the insertion direction.

4. The developer storing device according to claim 1, wherein
the container support portion includes
a container detection portion capable of detecting the developer container at the attachment position,
the container body includes a protrusion portion which is detected by the container detection portion when the developer container is attached at the attachment position,
the container body is formed by blow-molding a molten resin between two molds attached to each other, and
the protrusion portion is formed by cavities formed on mating surfaces of the two molds.

5. An image forming apparatus, comprising:
an apparatus body;
an imaging portion which forms a developer image formed of developer on an image-carrying member;
a cleaning portion which removes used developer remaining on the image-carrying member;
a developer container capable of storing the used developer removed by the cleaning portion; and
a container support portion which retains the developer container inserted into the apparatus body from an opening formed on a side surface of the apparatus body at a predetermined attachment position, wherein
the container support portion includes
a bottom surface support portion which supports a bottom surface of the developer container, and
a stopper member which is provided at an upper edge portion of the opening and is supported while being movable between a predetermined evacuation position and a protrusion position at which the stopper member protrudes downwardly from the evacuation position, and
the developer container includes
a container body,
an inlet which is provided near a first end portion of an upper surface of the container body on a side of an insertion direction of the developer container, and causes the developer to flow into the container body,
an engagement portion which is provided more on a side of a drawing direction opposite to the insertion direction than the inlet on the upper surface of the container body, and engages with the stopper member positioned at the protrusion position to restrict a movement of the developer container in the drawing direction, and
a step portion which extends toward the drawing direction from a second end portion of a bottom surface of the container body on the side of the insertion direction, and causes, while the inlet passes by the stopper member when the developer container is inserted or drawn out, the container body to be displaced downwardly so that the inlet is separated from the stopper member.
